(19) United States
(12) Patent Application Publication
(10) Pub. No.: US 2006/0151542 A1
(43) Pub. Date: Jul. 13, 2006

(54) Easy operating container

(76) Inventors: Akiko Taneko, Kobe (JP); Masako Hiratsuka, Suita (JP); Qingge Mao, Kobe (JP)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/033,227

(22) Filed: Jan. 11, 2005

(51) Int. Cl. G01F 11/36

(52) U.S. Cl. 222/321.9

(57) ABSTRACT

A container is disclosed. The container has a body with a top end and a bottom end, a pump with an upper end and a lower end, a nozzle which is connected to the upper end of the pump and a hand rest which is located between the nozzle and the body for allowing one finger operation to push the upper end of the pump when the body is held at one hand. The lower end of the pump is connected to the top end of the body. In addition, the nozzle has a finger position thereupon. In some embodiments, the container can be used when it rests on a surface such as a table top, and also can be used in a portable manner to dispense products while being held with one hand.

### FIELD OF THE INVENTION

The present invention relates to containers. Specifically, the present invention relates to easy operating containers.

### BACKGROUND OF THE INVENTION

There are many types of containers in the market. These containers are, in general, divided into four categories: spray type, pump type, squeeze type and pouring type. Spray types are mainly used for insecticide sprays, air refresher, deodorants, in contrast, pump types and squeeze types are mainly used for dishwashing detergents, shampoos, rinses and conditioners, hand wash detergents and body wash detergents. Pouring types are used for general liquids or powders.

It has now been found that users would like at least dual functions for pump type containers: table top usage and portable usage. Table top usage means that users place the container on a surface and push the pump to dispense the product to the target location, such as a sponge, their hands or towels. Portable usage means that users apply the product directly to the target location such as pans, cutting boards or hairs.

However, it is not always easy to use containers designed for table top usage as a portable usage because sometimes the body of the container is too thick to hold. Even if the body of the container is sufficiently thin, users hands are usually slippery in a kitchen or bathroom because of dishwashing detergents or shampoos and thus, users may feel it difficult to hold and operate the container of detergents or shampoos. In those situations, users need to operate the pump with one hand because the other hand is occupied with a sponge or is taking care of their hair.

Therefore, there is a need to provide a container which not only can be used for table top usage but also can easily dispense products while being held for portable usage with one hand.

### SUMMARY OF THE INVENTION

The present invention relates to a container comprising a body, a pump, a nozzle and a hand rest. The body of the container has a top end and a bottom end. The pump of the container has an upper end and a lower end. The lower end of the pump is connected to the top end of the body. The nozzle is connected to the upper end of the pump. Also, the nozzle comprising a finger position thereupon. The hand rest is located between the nozzle and the body for allowing one finger operation to push the upper end of the pump when the body is held at one hand.

The container of the present invention provides a container which can easily dispense products in conditions on which users need to dispense the product by one hand. For example, such conditions are: holding a sponge at one hand, holding a plate in a kitchen sink at one hand, washing or rinsing hairs at one hand etc. In these situations, users' hand or containers themselves are very slippery by attached detergents or water, so if users use normal containers, users may feel difficulty to hold containers. Even if they can hold containers, they cannot push nozzles of containers by one hand. However, as the container of the present invention has a hand rest, even in these slippery conditions, users easily push the nozzle and dispense products by one hand.

The container of the present invention can contain any types of products, however, to show the strong benefit of the container, the container of the present invention preferably contains a dishwashing composition, a shampoo composition, a rising composition, conditioners, hand wash detergents or body wash detergents because these products may be used either containers or users' hands are wet or slippery.

### BRIEF DESCRIPTION OF THE FIGURES

FIG. 1 shows a preferred embodiment of the container of the present invention having a hand rest which is a projection.

FIG. 2 shows a preferred embodiment of the container of the present invention having a body and a hand rest which is a projection.

FIG. 3 shows a preferred embodiment of the container of the present invention having a hand rest which is a grip.

FIG. 4 shows a preferred embodiment of the container of the present invention having a hand rest which has more than one grip.

FIG. 5 shows a right view of a preferred embodiment of the container of the present invention having a hand rest which is a projection.

FIG. 6 shows a front view of a preferred embodiment of the container of the present invention having a hand rest which is a projection.

FIG. 7 shows a left view of a preferred embodiment of the container of the present invention having a hand rest which is a projection.

FIG. 8 shows a back view of a preferred embodiment of the container of the present invention having a hand rest which is a projection.

FIG. 9 shows a perspective view of a preferred embodiment of the container of the present invention having a hand rest which is a projection.

FIG. 10 shows a bottom view of a preferred embodiment of the container of the present invention having a hand rest which is a projection.

FIG. 11 shows a top view of a preferred embodiment of the container of the present invention having a hand rest which is a projection.

FIG. 12 shows a right view of another preferred embodiment of the container of the present invention having a hand rest which is a projection.

FIG. 13 shows a front view of another preferred embodiment of the container of the present invention having a hand rest which is a projection.

FIG. 14 shows a left view of another preferred embodiment of the container of the present invention having a hand rest which is a projection.

FIG. 15 shows a back view of another preferred embodiment of the container of the present invention having a hand rest which is a projection.

FIG. 16 shows a perspective view of another preferred embodiment of the container of the present invention having a hand rest which is a projection.

FIG. 17 shows a bottom view of another preferred embodiment of the container of the present invention having a hand rest which is a projection.

FIG. 18 shows a top view of another preferred embodiment of the container of the present invention having a hand rest which is a projection.

FIG. 19 shows a right view of another preferred embodiment of the container of the present invention having a hand rest which is a projection.

FIG. 20 shows a front view of another preferred embodiment of the container of the present invention having a hand rest which is a projection.

FIG. 21 shows a left view of another preferred embodiment of the container of the present invention having a hand rest which is a projection.

FIG. 22 shows a back view of another preferred embodiment of the container of the present invention having a hand rest which is a projection.

FIG. 23 shows a perspective view of another preferred embodiment of the container of the present invention having a hand rest which is a projection.

FIG. 24 shows a bottom view of another preferred embodiment of the container of the present invention having a hand rest which is a projection.

FIG. 25 shows a top view of another preferred embodiment of the container of the present invention having a hand rest which is a projection.

FIG. 26 shows a right view of another preferred embodiment of the container of the present invention having a hand rest which is a projection.

FIG. 27 shows a front view of another preferred embodiment of the container of the present invention having a hand rest which is a projection.

FIG. 28 shows a left view of another preferred embodiment of the container of the present invention having a hand rest which is a projection.

FIG. 29 shows a back view of another preferred embodiment of the container of the present invention having a hand rest which is a projection.

FIG. 30 shows a perspective view of another preferred embodiment of the container of the present invention having a hand rest which is a projection.

FIG. 31 shows a bottom view of another preferred embodiment of the container of the present invention having a hand rest which is a projection.

FIG. 32 shows a top view of another preferred embodiment of the container of the present invention having a hand rest which is a projection.

FIG. 33 shows a right view of another preferred embodiment of the container of the present invention having a hand rest which is a projection.

FIG. 34 shows a front view of another preferred embodiment of the container of the present invention having a hand rest which is a projection.

FIG. 35 shows a left view of another preferred embodiment of the container of the present invention having a hand rest which is a projection.

FIG. 36 shows a back view of another preferred embodiment of the container of the present invention having a hand rest which is a projection.

FIG. 37 shows a perspective view of another preferred embodiment of the container of the present invention having a hand rest which is a projection.

FIG. 38 shows a bottom view of another preferred embodiment of the container of the present invention having a hand rest which is a projection.

FIG. 39 shows a top view of another preferred embodiment of the container of the present invention having a hand rest which is a projection.

### DETAILED DESCRIPTION OF THE INVENTION

All percentages, ratios and proportions herein are by weight of the final dishwashing composition, unless otherwise specified. All temperatures are in degrees Celsius (° C.) unless otherwise specified.

As used herein, the term “comprising” and its derivatives means are intended to be open ended terms that specify the presence of the stated features, elements, components, groups, integers, and/or steps, but do not exclude the presence of other, unstated features, elements, components, groups, integers, and/or steps. This definition also applies to words of similar meaning, for example, the term “have”, “include”, “be provided with” and their derivatives. This term encompasses the terms “consisting of” and “consisting essentially of”.

As used herein, the term “dish” means any dishware, tableware, cookware, glassware, cutlery, cutting board, food preparation equipment, etc. which is washed prior to or after contacting food, being used in a food preparation process and/or in the serving of food.

As used herein, the term “one finger operation” means that a nozzle is pushed by one finger selected from a thumb, an index finger, and the middle finger without slipping the nozzle, bottle and/or finger.

As used herein, the term “hand rest” means a portion which can stop, prevent or reduce slipping of the container from the user's fingers or hands and allow one finger operation to push the pump when the body of the container is held at one hand.

As used herein, the term “projection” means one type of the hand rest. The projection type hand rest makes users' hands or fingers contact a body of a container when users hold the container.

As used herein, the term “grip” means one type of the hand rest. The grip type hand rest makes users' hands or fingers contact a body of the container when users hold the container.

As used herein, the term “table top” means a condition in which users can push a nozzle of the container without contacting the body of the container.

As used herein, the term “portable” means a condition in which users can push the nozzle of the container while they are contacting the body of the container.

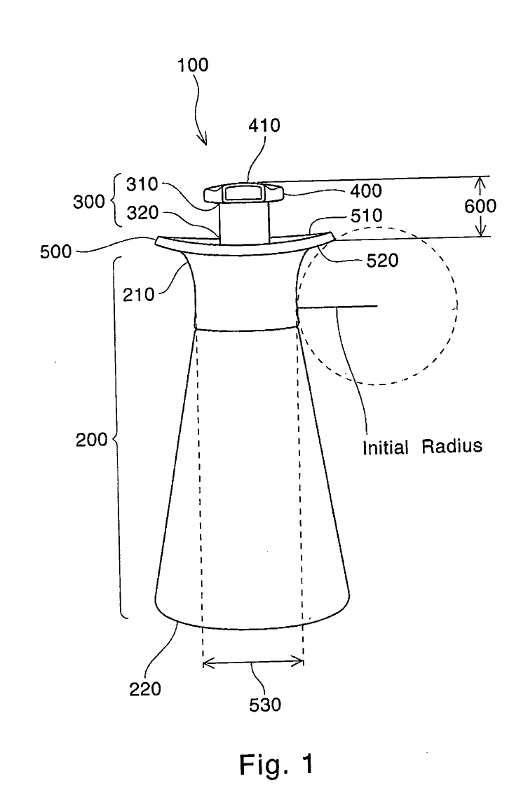

Referring to FIG. 1, a container, generally indicated at 100, is illustrated which has a body 200, a pump 300, a nozzle 400 and a hand rest 500. The container 100 is a hollow

The shape of the body 200 of the present invention is not limited to any particular shape. The unrestricted example of the shape of the body 200 can be an elongated tube, cone or partial cone. The material of the body 200 of the present invention may be, for example, plastic, resin, glass, metal or combinations thereof. The body 200 has a top end 210 and bottom end 220.

The pump 300 has an upper end 310 and a lower end 320 and which is connected to the top end 210 of the body 200. The pump 300 of the present invention can be a foam pump or a liquid pump. Preferred foam pumps are available from Air Spray Corporation (Alkmaar, Netherland), K&K Corporation (Osaka, Japan), Keltec Corporation (Druen, Netherland). Preferred liquid pumps are available from Air Spray Corporation, Yoshino Seisakusho Kabushiki Kaisha (Tokyo, Japan), Toyo Seikan Kabushiki Kaisha (Tokyo, Japan). The pump material may be, for example, plastics, resins, glass, metal or combinations thereof.

The nozzle 400 is connected to the upper end 310 of the pump 300 and has a finger position 410 thereupon. The distance 600 between the finger position 410 and the top end 210 is important because if the distance 600 is too far, finger may not be able to reach the finger position 410 of the nozzle 400, while if the distance 600 is too short, the nozzle 400 may not have sufficient depression distance and may not be able to provide sufficient amount of product from the container 100. The distance 600 is, preferably, from about 10 mm to about 100 mm, more preferably, from about 10 mm to about 70 mm, and further more preferably, from about 20 mm to about 50 mm.

The finger position 410 can be located anywhere on the nozzle 400 as long as user can push the finger position. The finger position 410 can be indicated by, for example, different coloring, a recess or a different texture.

The hand rest 500 is located between the nozzle 400 and the body 200 for allowing one finger operation to push the upper end 310 of the pump 300 when the body 200 is held with one hand. The hand rest 500 can be in any form as long as the hand rest 500 can allow one finger operation. However, the hand rest 500 is, preferably, selected from the group consisting of a projection and a grip. More preferably, the hand rest 500 is a projection.

The hand rest 500 shown in FIG. 1 is a preferred example of a projection. The minimum diameter 530 of the hand rest 500 is from about 10 mm to about 100 mm, preferably, from about 20 mm to about 60 mm. If the minimum diameter is too big, users may not be able to hold the container. If the minimum diameter is too small, users feel difficulty to push the nozzle since all finger is placing too close. However, this situation can be avoided by having big enough minimum diameter for the hand rest, so that user can adjust the holding position.

The hand rest 500 has a first surface 510 and a second surface 520. One or more fingers from user's hand preferably contact the second surface 520 of the hand rest 500 so that users can hold the container 100 more stably and securely.

An initial radius of curvature of the inside of the hand rest 500 is from about 0.1 mm to about 80 mm, preferably from about 0.1 mm to 24 mm, more preferably, from about 5.5 mm to 12 mm. A radius of curvature is defined in Dictionary of Plastic Technology, p684, published by Kabushiki Kaisha Kogyo Chosakai in 1994. According to the reference, a radius of curvature is defined as a circle radius which is the most closest to the given curve at the given point on the curve. The initial radius is shown in FIG. 1.

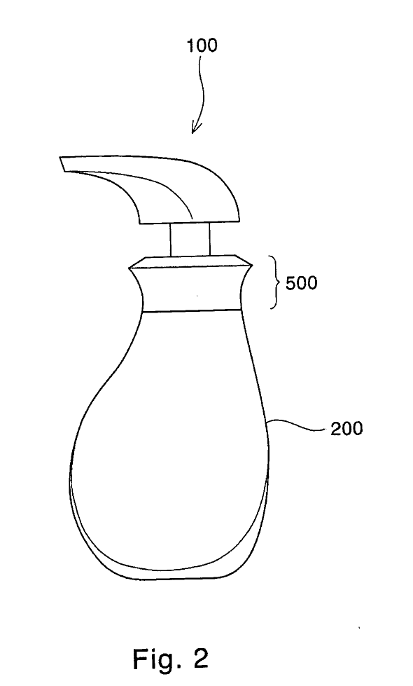

FIG. 2 shows a preferred embodiment of the container of the present invention having a body and a hand rest which is a projection.

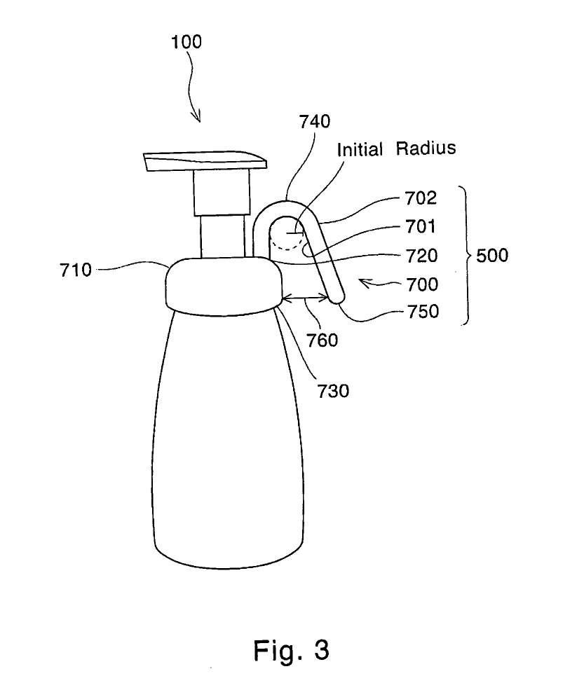

FIG. 3 shows a preferred embodiment of the container of the present invention having a hand rest which is a grip.

The container 100 in FIG. 3 has the hand rest 500 having a grip 700. The hand rest 500 has a grip 700, a grip base 710, a curve 740 and a terminal end 750. The grip has an inside 701 and outside 702. The grip base 710 has a first surface 720 and a second surface 730. The grip 700 starts from the first surface 720 of the grip base 710 and sis shaped at the curve 740 so that users' finger can support the inside 701 of the grip 700 until the terminal end 750. A space 760 is defined as a minimum distance between the terminal end 750 and the grip base 710. Preferably, the space 760 is from about 10 mm to about 50 mm, more preferably from about 11 mm to about 25 mm. If the space is too narrow, users may not be able to hold the grip and if the space is too big, users may have difficulties to push the nozzle.

Preferably, the curve 740 is a part of a circle having an initial radius of curvature of from about 0.1 mm to about 80 mm, more preferably, from about 0.1 mm to about 24 mm, much more preferably, from about 5.5 mm to about 12 mm. The initial radius of curvature is shown in FIG. 3.

The container of the present invention can have more than one grip, preferably two grips.

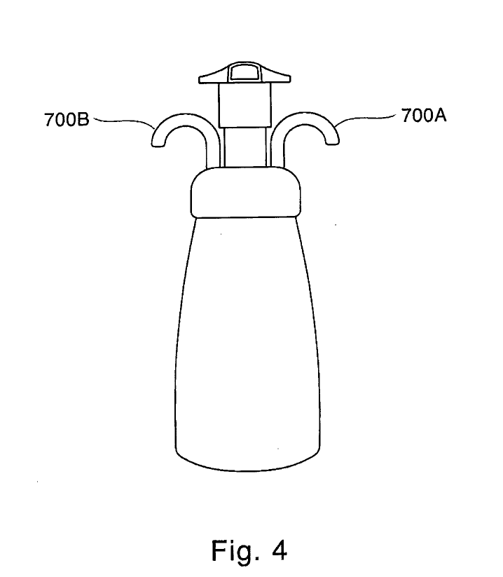

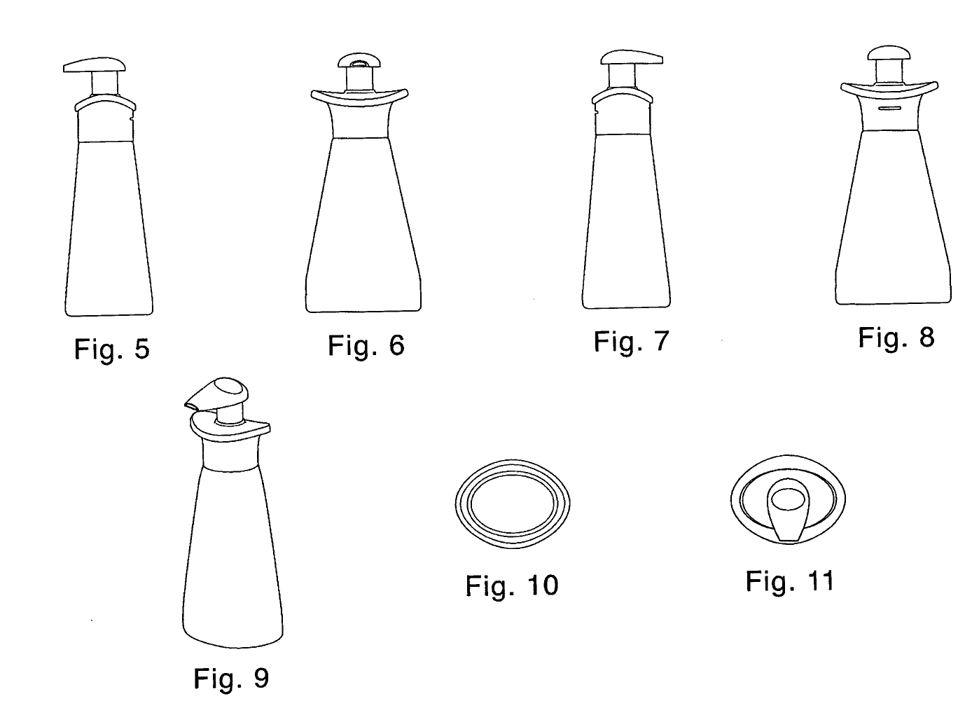

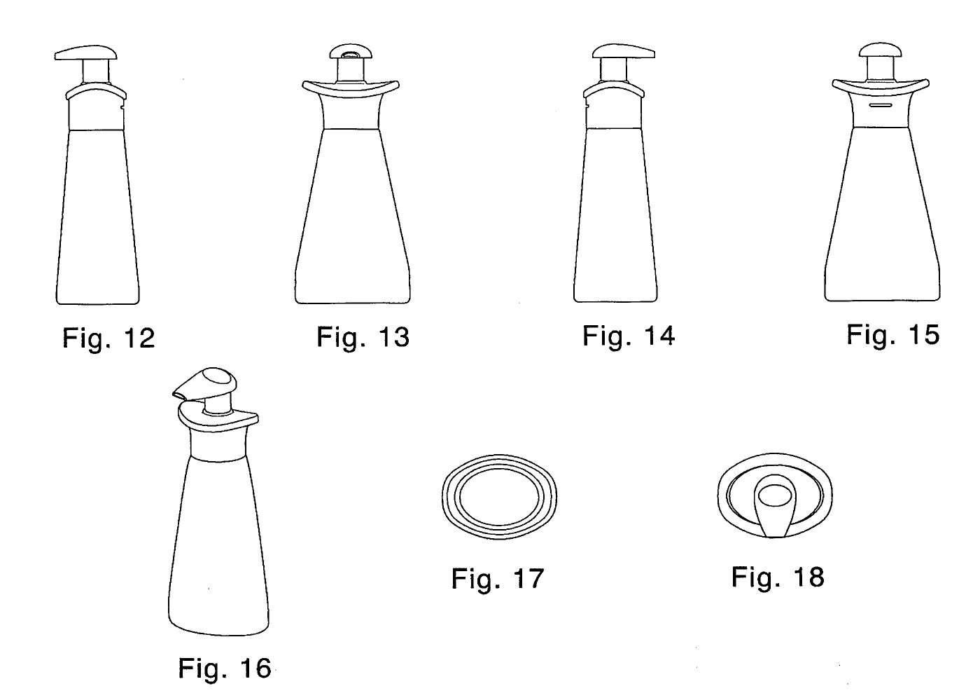

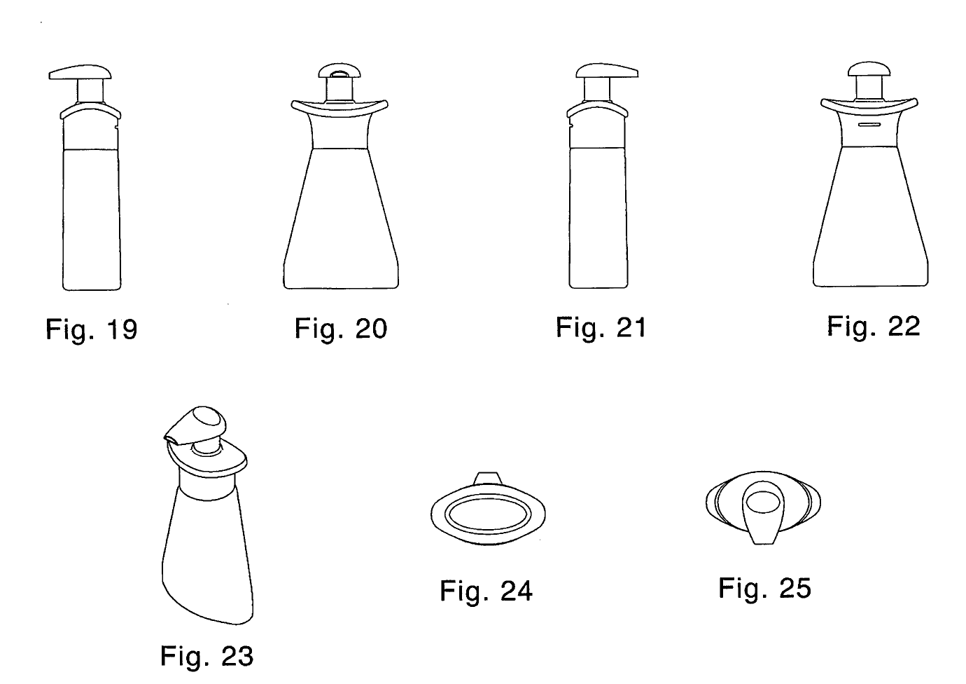

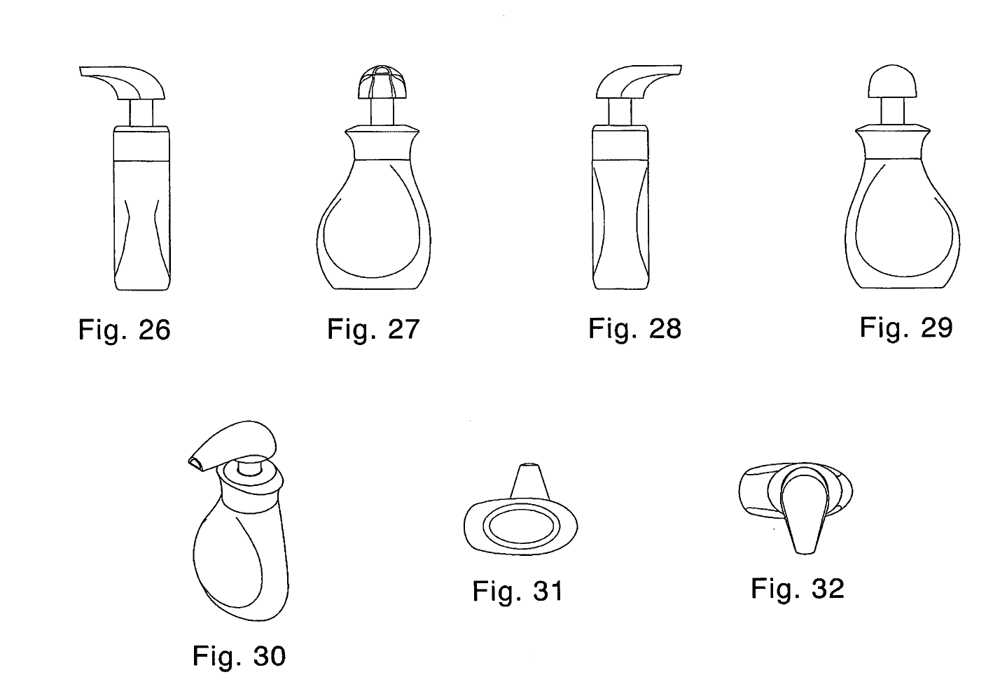

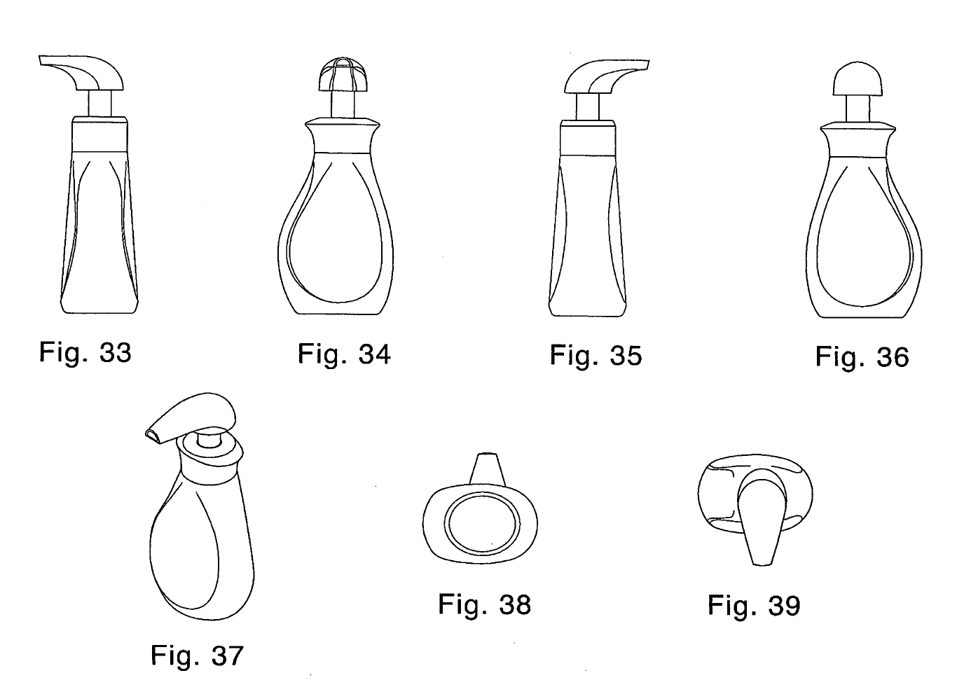

FIG. 4 shows a preferred embodiment of the container of the present invention having a hand rest which has more than one grip.

The container in FIG. 4 has first grip 700A and second grip 700B. These two grips are preferably located at opposing positions.

### EXAMPLE

Preparation

(1) Three containers for test were prepared: Container A (normal container-no hand rest); Container B (with a hand rest, projection type shown in FIG. 1); and Container C (with a hand rest, grip type shown in FIG. 3).

(2) To make the containers slippery condition, 0.2 g of liquid dish washing detergent was poured onto a paper towel, then applied to the outside of the test containers, then wiped off the excess detergent.

(3) To eliminate influence of nozzle length, 1.5(W)×2.5(L) cm of thick paper with white tape was attached and the total length of the nozzle was adjusted to about 6.8 cm

Test 1: Container for Table Top Usage

1) 10 well-trained panelists were asked to hold a sponge with one hand and to push the nozzle of each container (Container A, B and C) with the other hand, twice, so as to dispense product.

2) Product preference for ease of pushing the nozzle was rated on a 0-100 scale by the panelists. “0” means “almost impossible” to push the nozzle, while “100” means “very easy” to push the nozzle.

The result is shown in TABLE 1. As shown in TABLE 1, the container of the present invention (Containers B and C) shows almost equal easiness for pushing nozzle as a table top usage.

Test 2: Container for Portable Usage

1) One plate was prepared in a sink.

1) The same panelist of test 1 were prepared and asked them to hold the same containers with one hand and to push the nozzle of each container with the ‘index finger’ so as to dispense the product onto the plate in the sink.

2) Product preference for ease of holding degree of slipperiness were rated on a 0-100 scale by the panelists. “0” means “almost impossible” to push the nozzle with one finger, while “100” means “very easy” to push the nozzle with one finger.

The result between Container A and B is shown in TABLE 2-A. The result between Container A and C is shown in TABLE 2-B. In test 2, panelists needed to push the nozzle with one finger. When they use Container A, they could not hold the container well (See the result of the average score). As a result, panelists could not push the nozzle well due to the slippery body of the container. However, as Containers B and C have the hand rests of the present invention, users may easily hold the body of the container and as a result, one finger operation was easily performed.

TABLE 1-A

Easiness of Push (0-100)

| Panelist number | Container A | Container B |
|---|---|---|
| 1 | 60 | 50 |
| 2 | 70 | 70 |
| 3 | 50 | 50 |
| 4 | 90 | 80 |
| 5 | 60 | 70 |
| 6 | 50 | 50 |
| 7 | 50 | 60 |
| 8 | 90 | 90 |
| 9 | 50 | 50 |
| 10 | 40 | 40 |
| Average | 61 | 61 |

TABLE 1-B

Easiness of Push (0-100)

| Panelist number | Container A | Container C |
|---|---|---|
| 1 | 40 | 50 |
| 2 | 60 | 70 |
| 3 | 50 | 50 |
| 4 | 80 | 80 |
| 5 | 70 | 70 |
| 6 | 60 | 50 |
| 7 | 50 | 80 |
| 8 | 80 | 80 |
| 9 | 50 | 50 |
| 10 | 40 | 40 |
| Average | 58 | 62 |

TABLE 2-A

| Panelist | Easiness of Hold (0-100) | | Non-Slippery degree (0-100) | |
|---|---|---|---|---|
| number | Container A | Container B | Container A | Container B |
| 1 | 20 | 0 | 20 | 20 |
| 2 | 20 | 90 | 0 | 90 |
| 3 | 20 | 50 | 20 | 60 |
| 4 | 40 | 70 | 20 | 90 |
| 5 | 40 | 80 | 30 | 90 |
| 6 | 0 | 80 | 0 | 80 |
| 7 | 50 | 40 | 0 | 80 |
| 8 | 30 | 40 | 10 | 70 |
| 9 | 10 | 50 | 10 | 50 |
| 10 | 10 | 30 | 10 | 70 |
| Average | 24 | 53 | 12 | 70 |

TABLE 2-B

| Panelist | Easiness of Hold (0-100) | | Non-Slippery degree (0-100) | |
|---|---|---|---|---|
| number | Container A | Container C | Container A | Container C |
| 1 | 10 | 60 | 50 | 70 |
| 2 | 20 | 60 | 0 | 80 |
| 3 | 20 | 40 | 10 | 30 |
| 4 | 40 | 80 | 20 | 80 |
| 5 | 40 | 60 | 30 | 80 |
| 6 | 0 | 30 | 0 | 50 |
| 7 | 50 | 70 | 0 | 90 |
| 8 | 10 | 60 | 10 | 80 |
| 9 | 10 | 50 | 10 | 70 |
| 10 | 10 | 40 | 10 | 80 |
| Average | 21 | 55 | 14 | 71 |

All documents cited in the Detailed Description of the Invention are, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A container comprising:
(a) a body comprising a top end and a bottom end;
(b) a pump comprising an upper end and a lower end wherein the lower end of the pump is connected to the top end of the body;
(c) a nozzle connected to the upper end of the pump, the nozzle comprising a finger position thereupon; and
(d) a hand rest which is located between the nozzle and the body for allowing one finger operation to push the upper end of the pump when the body is held at one hand.

2. The container according to claim 1, wherein the hand rest comprises a first surface and a second surface and wherein a finger contacts the second surface of the hand rest when the body is held with one hand.

3. The container according to claim 1, wherein the distance between the finger position to the hand rest is from about 10 mm to about 100 mm.

4. The container according to claim 1, wherein the hand rest is selected from the group consisting of a projection and a grip.

5. The container according to claim 4, wherein the hand rest is a projection.

6. The container according to claim 5, wherein the minimum diameter of the hand rest is from about 10 mm to about 100 mm.

7. The container according to claim 4, wherein the hand rest is a grip.

8. The container according to claim 7, wherein the grip comprises a curve which is a part of a circle comprising an initial radius of curvature of from about 0.1 mm to about 80 mm.

9. The container according to claim 8, wherein the container comprises more than one grip.

10. The container according to claim 9, wherein the container comprises two grips.
